(19) United States
(12) Patent Application Publication
(10) Pub. No.: US 2022/0143442 A1
(43) Pub. Date: May 12, 2022

(54) FIRE-RETARDANT DISTRIBUTION SYSTEM

(71) Applicants: Paul David MacNeal, Granada Hills, CA (US); Dane Mark Surur, Lancaster, CA (US)

(72) Inventors: Paul David MacNeal, Granada Hills, CA (US); Dane Mark Surur, Lancaster, CA (US)

(21) Appl. No.: 17/454,736

(22) Filed: Nov. 12, 2021

Related U.S. Application Data
(60) Provisional application No. 63/112,759, filed on Nov. 12, 2020.

(51) Int. Cl. A62C 35/13; A62C 37/50; A62C 35/02

(52) U.S. Cl. CPC A62C 35/13; A62C 3/02; A62C 35/026; A62C 37/50

(57) ABSTRACT

A system for fire suppression comprising: a container; an agitator; a pump; a distribution head; and a control module; wherein the container is configured to store a fire retardant; wherein the agitator is housed within the container; and wherein the pump is configured to draw the fire retardant to the distribution head; wherein the agitator is configured to periodically agitate the fire retardant.

### CROSS-REFERENCE TO RELATED APPLICATIONS

This Non-Provisional Application claims the benefit of and priority to U.S. Provisional Patent Application No. 63/112,759, filed on Nov. 12, 2020, by inventor Paul David MacNeal, the contents of which are expressly incorporated herein by this reference.

### BACKGROUND

Wildfires have grown larger and have increased in intensity over the last several decades. Compared with 1986, wildfires today in the western United States occur nearly four times more often, burn more than six times the land area, and last almost five times as long. By 2017, 11 of the 20 most destructive wildfires in California occurred in preceding 10 years. The 2018 calendar year witnessed the most destructive wildfires in California history in terms of the loss of life, structures, and damage.

In the last decade, enormous wildfires have consumed vast swaths of land, including the 2013 Rim Fire impacting national park and national forest lands, the 2017 Napa Valley, Sonoma Valley, and Santa Rosa wildfires, the 2017 Thomas Fire affecting 200,000 acres, and the 2018 Camp Fire.

Wildfires in human occupied areas have resulted in enormous human and financial costs, which include the following:
(1) The 1991 Berkeley-Oakland Tunnel Fire, which resulted in 25 deaths, the loss of more than 3,000 homes, and a total financial loss of $1.5 billion in 1991 United States dollars.
(2) The 2003 San Diego Cedar Fire, which resulted in 15 deaths and the loss of 2,000 structures.
(3) The 2017 Tubbs Fire, which resulted in 22 deaths, the loss of 5,643 structures, and a total financial loss of approximately $1.3 billion in 2017 United States dollars.
(4) The 2017 Thomas Fire, which resulted in two deaths, the loss of more than 1,000 homes, and a total financial loss of approximately $2.2 billion in 2018 United States dollars
(5) The 2018 Camp Fire, which resulted in 89 deaths, the loss of 18,804 structures, and at least $12.4 billion in 2018 United States dollars in insured losses.
(6) In 2019 there were 6,872 fire incidents in California, burning more than 253,321 acres with 732 structures damaged or destroyed, three fatalities and a total financial loss of approximately $4.5 billion dollars.
(7) From January 2020 to October 2020 there have been 8,320 total fires that burned 4,267,386 acres, destroyed 10,308 structures with 37 injuries, 31 fatalities and a financial loss of approximately $1.808 billion in United States dollars.

Accordingly, what is needed is a way to protect areas from wildfires in a way that does not further endanger human life.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

One embodiment may be a system for fire suppression may comprise: a container; an agitator; a pump; a distribution head; a power source; and a control module; wherein the container may be configured to store a fire retardant; wherein the agitator may be housed within the container; and wherein the pump may be configured to draw the fire retardant to the distribution head. The agitator may be configured to periodically agitate the fire retardant. The distribution head may be configured to distribute the fire retardant in an area around the container. The distribution head may be configured to distribute the fire retardant up to 50 feet away from the container. The distribution head may be configured to distribute the fire retardant in a semicircular pattern. The distribution head may be configured to distribute the fire retardant in a circular pattern. The control module may be configured to activate and deactivate the pump, the distribution head, and the agitator. The system for fire suppression may comprise a float switch; wherein the float switch may be configured to detect when the fire retardant drops below a specified level within the container, at which point, the float switch may send a deactivation signal to the control module, and the control module deactivates the pump and the distribution head. The system for fire suppression may comprise a smoke sensor; wherein the smoke sensor may be configured to transmit a smoke activation signal to the control module when smoke over a predetermined level may be detected, and when the control module receives the smoke activation signal, the control module may be configured to activate the pump and the distribution head. The system for fire suppression may comprise a heat sensor; wherein the heat sensor may be configured to transmit a heat activation signal to the control module when heat over a predetermined level may be detected, and when the control module receives the heat activation signal, the control module may be configured to activate the pump and the distribution head. The power source may be a solar panel and battery. The system for fire suppression may further comprise a communication module; wherein the communication module may be configured to receive one or more instructions from a remote device. The communication module may be configured to transmit the instructions to the control module.

Another embodiment may be a system for fire suppression may comprise: two or more containers; and a control unit; wherein the two or more containers each comprise an agitator, a pump, and a distribution head; wherein the two or more containers may be configured to store a fire retardant and to distribute the fire retardant in an area around the two or more containers; wherein the control unit may be configured to activate and deactivate each of the two agitators and each of the two pumps; Each of the two or more containers may further comprise a float switch, wherein the float switch may be configured to detect when the fire retardant drops below a specified level within the container, at which point, the float switch sends a deactivation signal to the control module, and the control module deactivates the pump and the distribution head. The two or more containers may be configured to be positioned such that when the two or more containers distribute the fire retardant, the distributed fire retardant forms a barrier to prevent advancement of wildfires past the two or more containers.

A system for fire suppression comprising: a container; an agitator; a pump; a distribution head; a power source; a float switch; a communication module; and a control module; wherein the container may be configured to store a fire retardant; wherein the agitator may be housed within the container; wherein the pump may be configured to draw the fire retardant to the distribution head; wherein the agitator may be configured to periodically and automatically agitate the fire retardant; wherein the distribution head may be configured to distribute the fire retardant in an area around the container; wherein the distribution head may be configured to distribute the fire retardant up to 50 feet away from the container; wherein the distribution head may be configured to distribute the fire retardant in a semicircular pattern; wherein the control module may be configured to activate and deactivate the pump, the distribution head, and the agitator; wherein the float switch may be configured to detect when the fire retardant drops below a specified level within the container, at which point, the float switch sends a deactivation signal to the control module, and the control module deactivates the pump and the distribution head; wherein the communication module may be configured to receive one or more instructions from a remote device; and wherein the communication module may be configured to transmit the one or more instructions to the control module.

One object of the present disclosure is to provide additional and supplemental fire suppression systems to help safeguard property from wildfire. Fire-Retardant Distribution System (FRDS) may be placed strategically around the perimeter of the property (home or business, private or public) to provide on demand protection from an oncoming wildfire. When activated, the FRDS unit may spray a semi-circular (or other portions of a circle) pattern up to 46 feet in radius, or in some embodiments, up to 55 feet in radius. In alternate embodiments, the radius may be optimized for a specific use case by using different components or having different control mechanisms. In some scenarios it may be beneficial to have a smaller denser spray pattern, and in some embodiments it may be beneficial to have a larger spray pattern. In one embodiment, multiple FRDS units may be placed strategically around the property to create a continuous barrier around the perimeter of the property, or any other location where the user may want to have a protective fire retardant coverage. Preferably, this continuous barrier may be about 30 or more feet deep in protective fire retardant coverage. In one embodiment, the fire-retardant material may be a fire-resistant chemical that may be applied to vegetation pursuant the manufacturer's directions. In some embodiments, the fire retardant material may be reduced in efficacy if subjected to rain. After the FRDS units are used, they may be refilled with new fire retardant material for reuse.

The efficacy of the FRDS may be improved by using supplemental fire prevention techniques, such as removing brush and other property cleanup on a regular basis, and preferably in advance of wildfire season. Doing so reduces the amount of potential fuel for the wildfire to burn. Some of these supplemental fire prevention techniques may include: brush removal per fire department and county ordinance regulations; tree trimming of low hanging branches; tree removal of dead or densely packed trees; removal of loose leaves and tree foliage; removal of debris in rain gutters of the home or property; removal of debris on roof tops; removal (or relocation) of firewood that is too close to any structure; removal of other fire hazards near any structure; inspection of the home for potential fire hazards (such as wood shake roof covering).

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of one embodiment of a Fire-Retardant Distribution System unit.

FIG. 2 is an illustration of an exploded and cutaway view of the Fire-Retardant Distribution System unit.

FIG. 3 is an illustration of an exploded and cutaway view of another embodiment of a Fire-Retardant Distribution System unit.

FIG. 4 is an illustration of a control unit for use with a Fire-Retardant Distribution System unit.

FIG. 5 is an illustration of one embodiment of a potential layout involving the Fire-Retardant Distribution System.

FIG. 6 is an illustration of another embodiment of a potential layout involving the Fire-Retardant Distribution System.

FIG. 7 is a block diagram of one embodiment of a control unit for use with a Fire-Retardant Distribution system.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer- readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

As used herein, the term “vehicle” is understood to include large vehicles, recreational vehicles, and boats.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In various implementations, the interactive electronic device may be configured to send and receive messages to other interactive electronic devices, electronic communication devices, and the like.

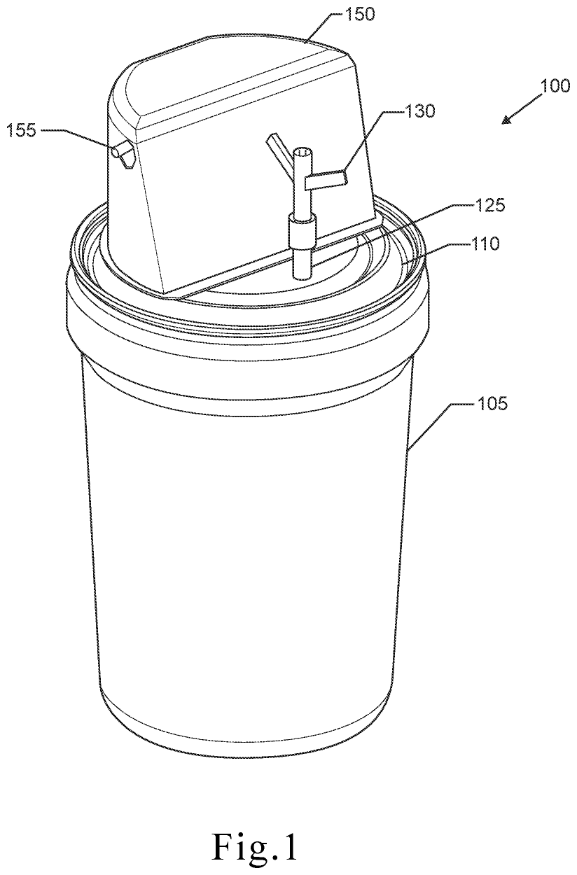

FIG. 1 is an illustration of one embodiment of a Fire-Retardant Distribution System unit. As shown in FIG. 1, the FRDS unit 100 may comprise a container 105, cap 110, pump 115, sleeve 120, pipe 125, distribution head 130, float sensor 135, agitator paddle 140, agitator motor 145, housing cover 150, and electronic connection component 155. Additionally, the FRDS unit may comprise a control module 160 and communication module 165.

The container 105 may be configured to house the pump 115, sleeve 120, float sensor 135, and agitator paddle 140. In some embodiments, the container 105 may also house the agitator motor 145. The cap 110 may be used to cover the container 105 and to provide a platform upon which the distribution head 130, housing cover 150, and electronic connection component 155 may be affixed. The housing cover 150 may be used to protect the various electronic components from the elements, including rain. In some embodiments, the control module 160 and communication module 165 may be located on top of the cap 110 and under the housing cover 150. In one embodiment, the container 105 may be a 30 gallon drum comprising high density polyethylene (HDPE) plastic. In one embodiment, the cap 110 may comprise a sealable opening to allow for inspection of the fire retardant.

In a preferred embodiment, the container 105 may be filled with a fire-retardant material that may be in a liquid suspension, colloidal, or other liquid solution. In an alternate embodiment, the fire retardant material may be a solid or powder, and the various components of the FRDS unit 100 may be altered, modified, or replaced in order to distribute solid or powder materials, instead of liquid materials, as contemplated herein. Because the fire retardant material may not be a pure liquid, and include various components that may settle and/or precipitate onto the bottom of the container 105 over time, the agitator paddle 140 may be configured to periodically agitate the fire retardant and re-mix or re-suspend the fire retardant. In a preferred embodiment, the agitator paddle 140 may be activated prior to distribution of the fire retardant through the distribution head 130. The agitator motor 145 may be configured to turn the agitator paddle 140. In some embodiments, the agitator motor 145 may be configured to turn the agitator paddle 140 at variable speeds. The agitator paddle 140 may be substantially any material configured to be cap 110 able of constant exposure to liquids and fire retardants without substantial degradation. The agitator paddle 140 may be configured to reach the bottom of the container 105 and engage a bushing mounted on the inner surface of the bottom of the container 105 to prevent lateral movement.

When the pump 115 is activated, fire retardant material may be drawn to the distribution head 130 and distributed around the container 105. In some embodiments, the fire retardant may be distributed in a semicircle, circle, or substantially any other shape with the size of the shape, or area of ground covered, dependent upon the rate of flow of fire retardant by the pump 115. In some embodiments, the fire retardant may be distributed in a semicircle around the container 105 having a radius of 46 feet. In some embodiments the radius may be 55 feet. In other embodiments, the fire retardant may be distributed in a circular shape around the container 105. The specifics of the radius and shape used may be determined by the user based on specifically what is trying to be protected from wildfires. In some embodiments, multiple FRDS unit 100s may be employed to distribute fire retardant along a barrier area. The distribution head 130 may be a sprinkler head, or other liquid/solution distribution mechanism. In one embodiment, the sprinkler head is a ¾″ NPT brass impact sprinkler with a 25-degree trajectory angle rated for 30 to 55 psi and has a maximum throw radius of 55 feet, which may have adjustment levers to specify the shape of the distributed spray pattern (e.g. full circle, semi-circle, quarter-circle, etc.). In some embodiments, the distribution head 130 may be angled in order to account for slopes or changes in the geographical area around the container 105.

The control module 160 may be configured to activate the pump 115 and agitator motor 145 when a pump 115 or agitator activation signal is received, or upon preprogrammed conditions. In one embodiment, the control module 160 may be configured to deactivate the pump 115 and agitator motor 145 when the fire retardant level within the container 105 drops below a predetermined amount. This may prevent unintended wear of the various components of the FRDS unit 100.

The pipe 125 may comprise a pipe 125 to attach the pump 115 to the distribution head 130. Preferably, threaded fittings utilize thread-sealing tape to minimize leakage. In one embodiment, a 1¼″ NPT adapter may transition the pump 115 threads from 1¼″ NPT threads to ¾″ NPT threads. A straight segment of ¾″ pipe 125 and coupler may attach the pump 115 outlet to the distribution head 130. To prevent twisting of the pipe 125 and pump 115 during operation, a flanged pipe 125 fitting may be secured to the vertical ¾″ pipe 125 at a height that allows for contact with the underside of the lid. A #10 screw may secure the flanged pipe 125 fitting to the lid.

The pump 115 may intake the fire-retardant mixture and pressurizes the mixture to force the fluid to be expelled through the pipe 125 and into the distribution head 130. In one embodiment, the pump 115 has an intake that is about 8 inches above the base of the pump 115. The height of the intake above the base may cause less of the fire-retardant material contained within the container 105 to be dispersed, but the remaining amount of fire-retardant material is accounted for when determining the amount of fire-retardant material to be placed in the container 105. In order to increase the amount of fire retardant to be distributed a sleeve 120 is included. In one embodiment, the pump 115 may operate at 115V and use 12 Amps of power. In one embodiment, the pump 115 is rated to have a discharge pressure of 50 psi when having a 20-foot depth in water and a 14 gallon per minute dispense rate. In one embodiment, the pump 115 is not self-priming. The base of the pump 115 may be prevented from moving laterally by a rubber ring that is attached to an inner surface of the bottom of the container 105. In one embodiment, the interface at the top of the pump 115 is a 1¼″ NPT Standard Pipe 125 Thread.

The container 105, cap 110, and housing cover 150 may preferably be made of a material that is resistant to the elements over a long period of time. In some embodiments, the container 105, cap 110, and housing may be made of a metal, plastic, polymer, or substantially any other rigid material.

The electronic connection component 155 may be configured to connect the FRDS unit 100 to a power source, such as an outlet. Preferably, the electronic connection component 155 may traverse the housing cover 150, and the point at which the electronic connection component 155 traverses the housing cover 150 may be made water tight by use of a soft foam rubber, or other sealing option. In alternate embodiments, the electronic connection component 155 may be configured to allow for multiple FRDS unit 100s to “daisy chain” with one another to a power and/or control source. In alternate embodiments, the FRDS unit 100 may comprise a self contained power source, such as a small power generator, solar panels, batteries, and/or combinations thereof.

The sleeve 120 may allow more fire-retardant material to be dispensed. In one embodiment, a rubber gasket located about 1″ above an intake screen of the pump 115 may provide a water-tight seal between the pump 115 sleeve 120 and the pump 115 body. The gasket may be configured to hold the pump 115 in place. In one embodiment, a metal worm drive hose clamp surrounds the pump 115 sleeve 120 and provides compressive force on the rubber gasket to help provide the water-tight seal. Marine-grade silicon sealant may be generously applied on all seams between the sleeve 120, the gasket, and the pump 115 to ensure the water-tight seal. The submersible pump 115 may have an intake that is about 8 inches above the pump 115 base. As the level of the fire-retardant mixture lowers inside the container 105, the sleeve 120 allows for additional fluid to be distributed due to the close proximity of the sleeve 120 next to the body of the pump 115. The sleeve 120 may surround the pump 115 with a radial clearance of ½″. With the sleeve 120 in place, an additional amount of fire-retardant material may be taken in prior to the pump 115 shutting off that is approximately 3 inches below the pump 115 intake. This translates to an additional distribution of about 5 gallons of fire-retardant material in the case that the container 105 is a 30 gallon container 105. In one embodiment, the pump 115 may be not self-priming, so it is preferably to remove trapped air between the sleeve 120 and the pump 115. When first filling the FRD with fire-retardant material, a ⅜″ diameter bleed hole in the pump 115 sleeve 120 may allow trapped air to escap 110e. Once the trapped air has completely escap 110ed, a rubber tapered plug is preferably installed. In this example, air is unlikely to inadvertently enter the intake to the pump 115 from the outside of the sleeve 120 during operation. Without the tapered plug being installed, air is likely to enter into the intake of the pump 115 when the fluid level lowers to the level of the bleed hole, which may cause a premature shutdown of the pump 115.

In some embodiments, the FRDS unit 100 may further comprise various sensors, such as heat and smoke sensors, which may be configured to cause the FRDS unit 100 to distribute the fire retardant if certain threshold limits are exceeded.

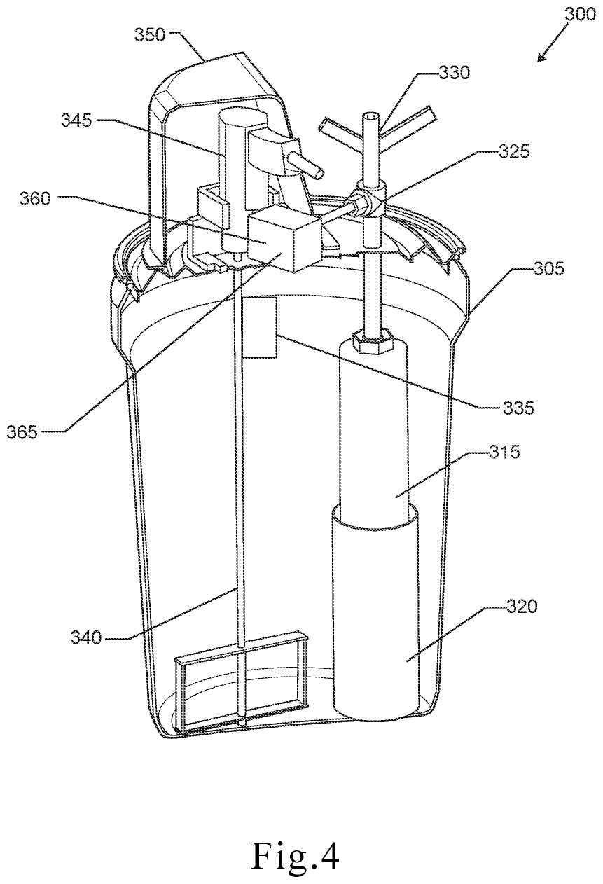

In some embodiments, the FRDS unit 100 may further comprise a control module 160 and communication module 165, similar to that shown in FIG. 4.

The communication module 165 may be configured to receive and/or transmit signals wirelessly or wiredly to remote devices. For example, in one embodiment, a user may be able to send a signal from their smart phone to the FRDS unit 100 through the communication module 165 to cause the FRDS unit 100 to distribute the fire retardant. In this manner, the user may be able to protect property or land from fire damage without any risk of human life. Additionally, the float sensor 135 may be configured to automatically shut down the pump 115 and agitator motor 145 when the fire retardant has been distributed. In some embodiments, the FRDS unit 100 may be configured to transmit signals to the remote device to advise about status of the FRDS unit 100, such as unusual readings or potential damage. In some embodiments, the FRDS unit 100 may be configured to transmit a signal to the remote device to inform the remote device when the FRDS unit 100 agitates or distributes the fire retardant. In some embodiments, the remote device may be a button or activation mechanism located on or near a structure to be protected that is intended for use only with the FRDS unit 100.

The control module 160 may be configured to activate and deactivate the pump 115 and/or agitator motor 145 depending on what signals the control module 160 receives. The signals may be received from remote devices, be pre-programmed based on time, or be received from one or more sensors in electronic communication with the control module 160.

In some embodiments, the control module 160 may comprise a heat sensor and/or smoke sensor.

In some embodiments, the control module 160 may comprise the communication module 165.

In some embodiments, a single control module 160 and communication module 165 may be shared by two or more FRDS units 100, such that all the interconnected FRDS units 100 act in unison.

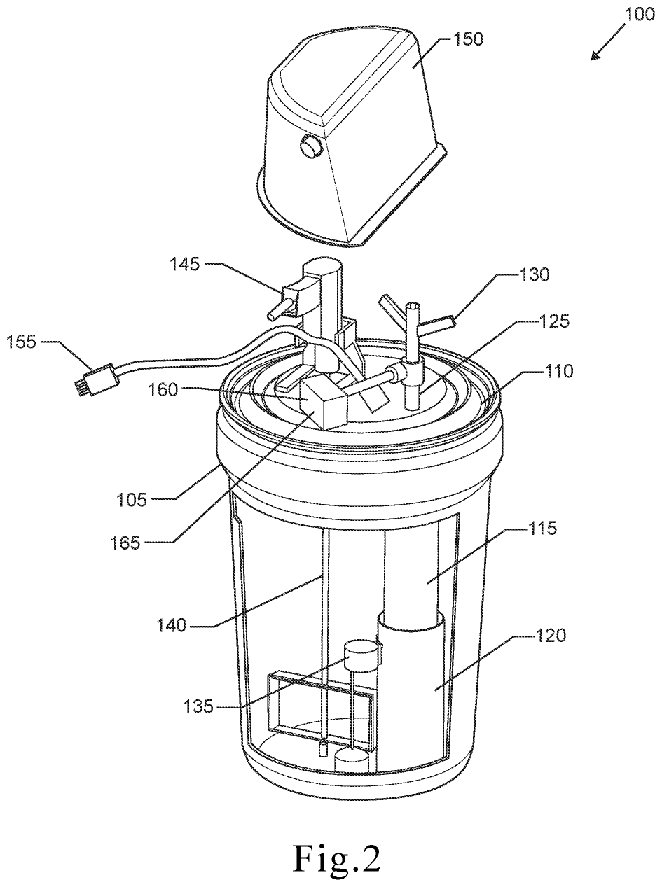

FIG. 2 is an illustration of an exploded and cutaway view of the Fire-Retardant Distribution System unit. FIG. 2 is an illustration showing the various components of the FRDS unit 100 described hereinabove.

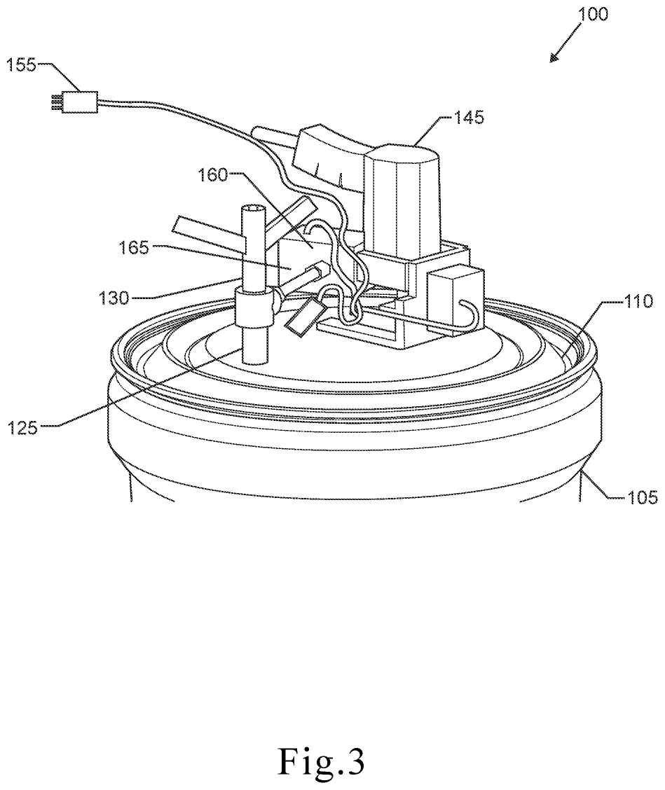

FIG. 3 is an illustration of an exploded and cutaway view of another embodiment of a Fire-Retardant Distribution System unit. The FRDS unit 300 shown in FIG. 3 is substantially similar to the FRDS unit 100 shown in FIG. 1, with the difference that the FRDS unit 300 utilizes pressure and temperature sensors 235, rather than a float sensor 135 to pause distribution of fire retardant.

FIG. 4 is an illustration of a control unit for use with a Fire-Retardant Distribution System unit. FIG. 4 is an illustration of the control unit of the FRDS unit 100, with the housing cover 150 removed in order to more clearly see the components housed therein.

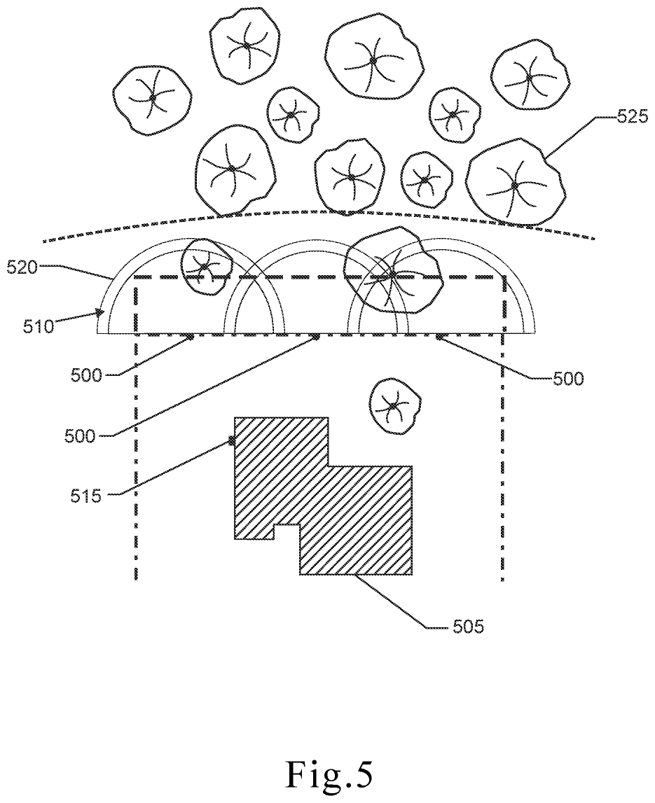

FIG. 5 is an illustration of one embodiment of a potential layout involving the Fire-Retardant Distribution System. As shown in FIG. 5, FRDS units 500 may be placed at specific locations outside a building 505 in order to enable distribution of fire retardant on an as needed basis, preferably by creating a zone of fire retardant material 510 that rests between potential wildfire fuel and a location or building to be protected.

In one embodiment, power may be drawn from the building at a single power providing location, and each of the FRDS units may be “daisy chained” together such that a minimal amount of power sources may be necessary. In one embodiment, one FRDS unit may receive power from a power source 515, and the other FRDS units may then receive power from an adjacent powered FRDS unit.

In one embodiment, 3 FRDS units 500 may be placed such that a solid wall of coverage of fire retardant may be deployed between the building 505 and wilderness 525, but it is understood that substantially any number of FRDS units 500 may be deployed simultaneously, provided that power source 515 and power flow are sufficient to operate all the FRDS units 500. In an alternate embodiment, each of the FRDS units 500 may be activated on a sequential basis, rather than all at once, in order to reduce the power required to operate the entire system.

Preferably, the area that the FRDS units are able to disperse fire retardant has been cleared of brush and other materials that wildfires may be able to use as fuel.

In some embodiments, multiple FRDS units 500 may be in electronic communication with a single control module 520, such that the single control module 520 may control the FRDS units 500.

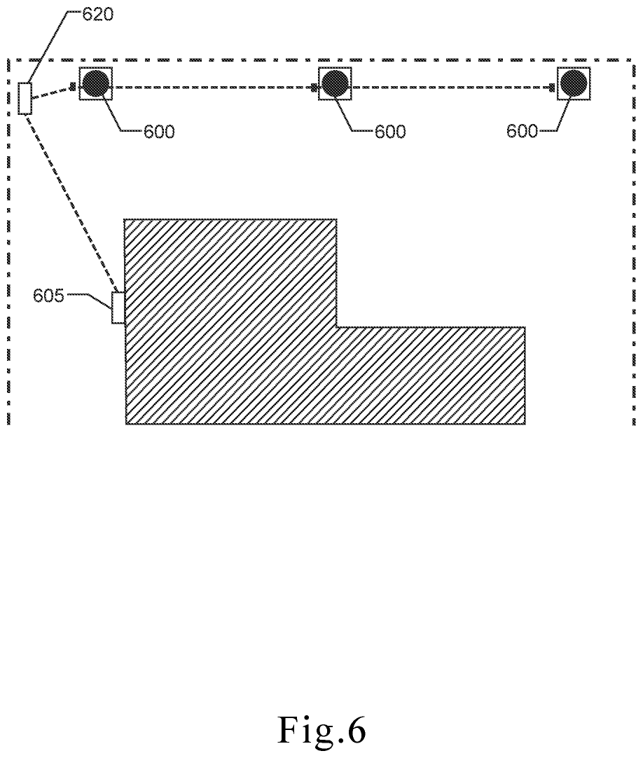

FIG. 6 is an illustration of another embodiment of a potential layout involving the Fire-Retardant Distribution System. As shown in FIG. 6, multiple FRDS units 600 may be separately and directly connected to a power source 605, such that each of the FRDS units may activate at the same time by drawing power from different circuits. In one embodiment, a single control module 620 may control the FRDS units 600.

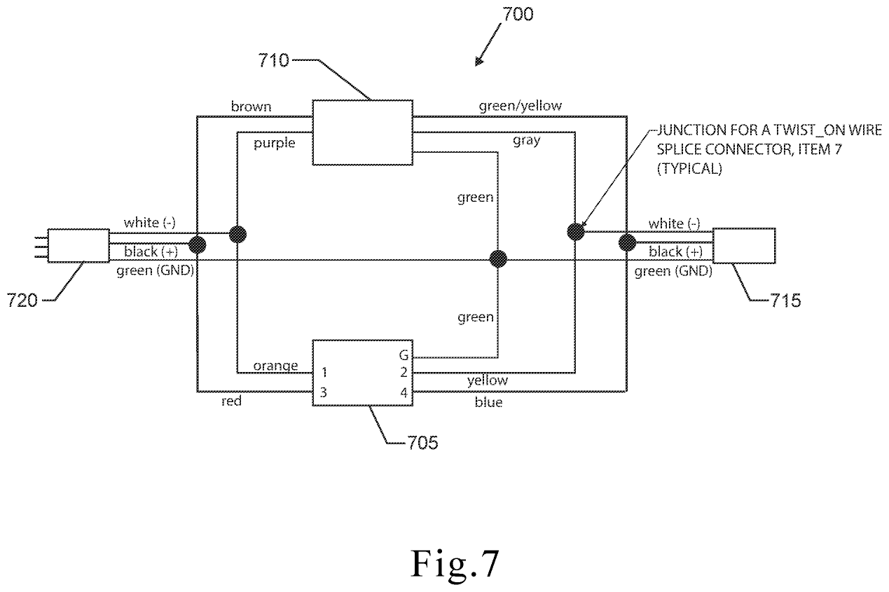

FIG. 7 is a block diagram of one embodiment of a control unit for use with a Fire-Retardant Distribution system. As shown in FIG. 7, the control unit 700 may comprise a pump pressure switch 705, a delayed timer relay 710, a female end 715, and a male end 720.

In alternate embodiments, the pump pressure switch 705 and/or delayed timer relay 710 may be substituted with a float sensor switch/relay, heat sensor switch/relay, smoke sensor switch/relay, or substantially any other sensor, which may be configured to provide signals to the control unit that may then be used to activate or deactivate an agitator and/or pump.

In view of the exemplary systems described herein, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A system for fire suppression comprising:
a container;
an agitator;
a pump;
a distribution head;
a power source; and
a control module;
wherein said container is configured to store a fire retardant;
wherein said agitator is housed within said container; and
wherein said pump is configured to draw said fire retardant to said distribution head.

2. The system for fire suppression of claim 1, wherein said agitator is configured to periodically agitate said fire retardant.

3. The system for fire suppression of claim 1, wherein said distribution head is configured to distribute said fire retardant in an area around said container.

4. The system for fire suppression of claim 3, wherein said distribution head is configured to distribute said fire retardant up to 50 feet away from said container.

5. The system for fire suppression of claim 4, wherein said distribution head is configured to distribute said fire retardant in a semicircular pattern.

6. The system for fire suppression of claim 4, wherein said distribution head is configured to distribute said fire retardant in a circular pattern.

7. The system for fire suppression of claim 1, wherein said control module is configured to activate and deactivate said pump, said distribution head, and said agitator.

8. The system for fire suppression of claim 7, further comprising a float switch;
wherein said float switch is configured to detect when said fire retardant drops below a specified level within said container, at which point, said float switch sends a deactivation signal to said control module, and said control module deactivates said pump and said distribution head.

9. The system for fire suppression of claim 7, further comprising a smoke sensor;
wherein said smoke sensor is configured to transmit a smoke activation signal to said control module when smoke over a predetermined level is detected, and when said control module receives said smoke activation signal, said control module is configured to activate said pump and said distribution head.

10. The system for fire suppression of claim 7, further comprising a heat sensor;
wherein said heat sensor is configured to transmit a heat activation signal to said control module when heat over a predetermined level is detected, and when said control module receives said heat activation signal, said control module is configured to activate said pump and said distribution head.

11. The system for fire suppression of claim 1, wherein said power source is a solar panel and battery.

12. The system for fire suppression of claim 1, further comprising a communication module;
wherein said communication module is configured to receive one or more instructions from a remote device.

13. The system for fire suppression of claim 12, wherein said communication module is configured to transmit said instructions to said control module.

14. A system for fire suppression comprising:
two or more containers; and
a control unit;
wherein said two or more containers each comprise an agitator, a pump, and a distribution head;
wherein said two or more containers are configured to store a fire retardant and to distribute said fire retardant in an area around said two or more containers; and
wherein said control unit is configured to activate and deactivate each of said two agitators and each of said two pumps.

15. The system for fire suppression of claim 14, wherein each said two or more containers further comprises a float switch, wherein said float switch is configured to detect when said fire retardant drops below a specified level within said container, at which point, said float switch sends a deactivation signal to said control module, and said control module deactivates said pump and said distribution head.

16. The system for fire suppression of claim 14, wherein said two or more containers are configured to be positioned such that when said two or more containers distribute said fire retardant, said distributed fire retardant forms a barrier to prevent advancement of wildfires past said two or more containers.

17. A system for fire suppression comprising:
a container;
an agitator;
a pump;
a distribution head;
a power source;
a float switch;
a communication module; and
a control module;
wherein said container is configured to store a fire retardant;
wherein said agitator is housed within said container;
wherein said pump is configured to draw said fire retardant to said distribution head;
wherein said agitator is configured to periodically and automatically agitate said fire retardant;
wherein said distribution head is configured to distribute said fire retardant in an area around said container;
wherein said distribution head is configured to distribute said fire retardant up to 50 feet away from said container;
wherein said distribution head is configured to distribute said fire retardant in a semicircular pattern;
wherein said control module is configured to activate and deactivate said pump, said distribution head, and said agitator;
wherein said float switch is configured to detect when said fire retardant drops below a specified level within said container, at which point, said float switch sends a deactivation signal to said control module, and said control module deactivates said pump and said distribution head;
wherein said communication module is configured to receive one or more instructions from a remote device; and
wherein said communication module is configured to transmit said one or more instructions to said control module.
